(19) United States
(12) Patent Application Publication
(10) Pub. No.: US 2011/0233068 A1
(43) Pub. Date: Sep. 29, 2011

(54) Ethylene Oxide Abator

(76) Inventor: P. Richard Warburton, Sewickely, PA (US)

(21) Appl. No.: 13/048,470

(22) Filed: Mar. 15, 2011

Related U.S. Application Data
(60) Provisional application No. 61/316,509, filed on Mar. 23, 2010.

(51) Int. Cl. C25B 1/22; C08J 5/20

(52) U.S. Cl. 205/554; 521/26

(57) ABSTRACT

Absorption of ethylene oxide is one of the methods commonly used to reduce air emissions from sterilization operations. Unlike prior art abators, the present method provides a means to regenerate the absorption medium within the abator and thus avoid the need to remove spent medium and load new medium every time the medium substantially consumed by the absorption process. Regeneration of the absorption medium is achieved through aqueous wash and air dry under ambient conditions and the regeneration cycle can be timed or automated as a function of medium consumption and regeneration of the liquid medium is achieved through electrochemical oxidation of the ethylene oxide reaction products.

### CROSS REFERENCE TO RELATED APPLICATIONS

This application claims priority from Ser. No. 61/316,509, Ethylene Oxide Abator, filed Mar. 23, 2010, the entire contents of which are incorporated by reference.

### FIELD OF THE INVENTION

The present invention relates to a method and device for reducing the concentration of ethylene oxide in a gas stream exhausting from a sterilization chamber.

### BACKGROUND OF THE INVENTION

The majority of medical items can be heat or steam sterilized, but those items that are heat or temperature sensitive are sterilized by a low temperature sterilization method. One method that has been in use since the 1950s is exposure of the items to be sterilized to ethylene oxide (EtO) gas. Ethylene oxide is an alkylating agent that destroys a wide range of pathogenic life forms, including viruses and even bacteria spores.

The ability to destroy a wide range of life forms makes EtO hazardous to anyone exposed to even low concentrations of the gas and makes EtO an environmental hazard to communities near the point of release. In addition to be toxic, and an irritant, EtO has been classified by the International Agency for Research on Cancer as a known human carcinogen. The US—Occupational Safety and Health Administration (OSHA) has promulgated regulations limiting the maximum permissible amount of EtO allowed in the workplace to 1 ppm calculated as a time weighted average over 8 hours and 5 ppm calculated as a time weighed average over 15 minutes [29 CFR 19101.1047]. Employers using EtO usually install continuous gas monitors for EtO to warn in the event of leaks, for example the Steri-Trac® monitor available from ChemDAQ Inc (Pittsburgh, Pa.).

Ethylene oxide sterilizers range in size from table top units about the size of a microwave oven to large room size chambers that a fork lift can drive inside to load and unload pallets of product. The US-Environmental Protection Agency (EPA), restricts the amount of ethylene oxide that can be released into the air from sterilization operations [40 CFR 63.363]. The EPA regulations limiting the amount of EtO that can be released depends on the amount of EtO used by that facility per year, for example these regulations require that the exhaust gases be scrubbed of ethylene oxide to less than 1 ppm or 99% efficiency for sources using more than 10 tons of EtO per year. Many states have regulations that are stricter than the federal requirements.

In order to meet these emission requirements, facilities pass the EtO laden exhaust gas from the sterilizers through scrubbers or abators to reduce the EtO concentration. There are three main technologies presently used to abate EtO. The first one is acid hydrolysis, in which the EtO is passed through a dilute solution of sulfuric acid in water. The acid catalyses the hydrolysis of the EtO to ethylene glycol. When the ethylene glycol concentration reaches a point that the hydrolysis reaction is no longer effective, the acid solution is replaced.

The second technology is catalytic combustion, in which the ethylene oxide is diluted with air so that it below the flammability limit (LEL=3% v/v in air) and passed through a hot catalytically active bed. The EtO is oxidized to carbon dioxide and water before being exhausted.

The third technology that has been developed is the absorption bed. In this method, the EtO is passed through an ambient temperature bed, filled with a material that binds the EtO. This bed has a finite capacity, and once it is substantially exhausted, the bed medium is replaced with fresh. This technology, which most commonly uses cationic ion exchange resins has been used for respiratory protection filter masks to remove EtO (Hammer & Kruse U.S. Pat. No. 4,813,410)

In order to ensure that the emissions from the abators meet the EPA or state agency's requirements, many users will install continuous EtO monitoring equipment, such as the EMCU™ system from ChemDAQ Inc., Pittsburgh, Pa. This equipment is especially beneficial on those abator technologies such as the absorption bed that are consumed by the abatement process since the monitor can provide an alert that the absorption medium is saturating and so should be replaced. The use of the monitor prevents premature replacement of the absorption medium which increases the costs for the facility and the inadvertent release of EtO resulting from the inability of saturated absorption medium to remove EtO from the gas stream.

Each of these technologies has their strengths and weaknesses. For example, the catalytic abators run at high temperature and so consume a lot of power in order to maintain their efficiency. The acid hydrolysis systems require little power, but have the disadvantage that rarely are they able to reduce the EtO concentration below the 1 ppm or lower limit required by the EPA or state agencies and thus a secondary abatement systems is also required. In many larger facilities more than one technology may be used, for example the first stage may be acid hydrolysis, followed by catalytic combustion or absorption bed to bring the emitted EtO concentration to less than 1 ppm.

The absorption bed technologies have the advantage that they are very simple to use, operate with little power beyond that needed to drive a simple fan, but the replacement medium for the beds is expensive and time consuming to change. All of these abator technologies come in a variety of sizes to meet the output demands of the sterilizers.

The absorption bed and acid hydrolysis type abators offer the lower energy solutions, but they both suffer from the need to change abator medium and the acid. The present invention builds on these old technologies to perform the same function as before, but with the improvement described herein of regenerating the absorption bed or acid in place. Regenerating the absorption bed and acid in place, gives the same advantages as the products of the current art, but relieves users of the burden of having to replace the absorption bed or acid.

The current absorption bed type of EtO abator consists of a large container filled with the EtO abator medium. Air containing EtO is blown in from one side, passes through the medium where the EtO is absorbed through chemical reaction with the surface of the medium, and passes on out to the exhaust. The filter medium used is a strong acid cationic exchange resin in hydrogen form [Kruse & Hammer, U.S. Pat. No. 4,828,810]. The ethylene oxide is believed to react with the surface of the ion exchange resin forming a bound product. Once essentially all of the reactive capability of the resin has been used, the now spent resin is discarded and replaced with fresh.

For the acid hydrolysis type of abator, the ethylene oxide is hydrolyzed to ethylene glycol and this builds up in the acid solution. Once the concentration of ethylene glycol reaches a sufficient level that the acid hydrolysis process becomes inefficient, the acid solution is replaced and the spent acid solution must be neutralized and disposed of according to EPA, state and local regulations.

The cost of replacing the abator medium is a significant part of the overall cost of ownership of an absorption type EtO abator; and the time and effort needed to remove the old abator medium and replace it with fresh medium adds a significant burden to the user of the abator.

### SUMMARY OF THE INVENTION

The present invention provides a means to regenerate the EtO abator at the point of use, without direct involvement of the user. This method for regeneration of the abator comes in two forms, one for the absorption type abator and the second for the acid hydrolysis type abator.

The construction of the absorption type regeneration abator is similar to the prior art absorption type abators, except means are provided to fill the abator medium chamber with a water based solution whenever the medium needs to be changed, allow sufficient time for the abator medium to hydrate and release the products of the reaction with ethylene oxide, drain the water and dry the abator medium by passing air through it.

The construction of the acid type regeneration abator is similar to the prior art acid hydrolysis type abators except that that acid contains an electrochemical cell in the acid circulation system.

This invention avoids the user needing to change either the abator absorption medium or the sulfuric acid in the acid hydrolysis abator. By regenerating the abator, the user can avoid the cost of replacing the abator medium each time it is becomes consumed by reaction with EtO and avoid the difficulties of handling sulfuric acid as well as the cost of disposing of the spent acid.

In addition, the regeneration process can be readily automated, so that the user need not be concerned with whether the abator medium needs to be replaced, keeping fresh abator medium on-hand incase the medium needs to be replaced and the general time and effort needed to replace the abator medium.

### BRIEF DESCRIPTION OF THE DRAWINGS

FIG. 1 is a diagram showing the absorption version of the regeneration abator.

FIG. 2 is a sketch of the acid hydrolysis version of the regeneration abator.

FIG. 3. is a sketch illustrating the regeneration chamber for the acid hydrolysis abator.

### DETAILED DESCRIPTION OF THE INVENTION

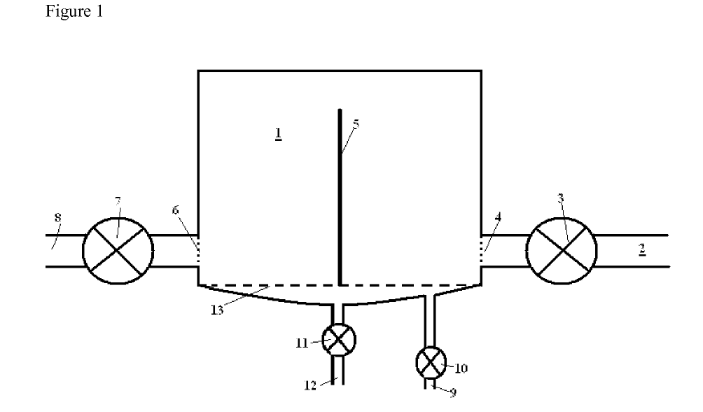

FIG. 1 shows the absorption regeneration abator which consists of an absorption chamber 1 in which the absorption medium (not shown) is placed. The gas stream containing the ethylene oxide enters from duct 2 through a valve 3 and through a screen 4 into the absorption chamber. The absorption chamber preferably contains various walls etc. 5 through which the gas flow must pass around in order to increase the gas path length through the absorption medium. The scrubbed gas exists the absorption chamber 1 through the screen 6 and out via valve 7 to exhaust duct 8. The medium can be a powder, but it is preferably small pellets or spheres and the screens 4 and 6 prevent the medium from moving into either the valves 3 and 7 or into the ducts 2 and 8.

The absorption medium in the absorption chamber 1 removes the ethylene oxide from the gas stream until the medium is substantially saturated and can no longer efficiently remove ethylene oxide. The determination that the medium is substantially saturated may be determined by prior experience of how much ethylene oxide the medium can absorb and knowledge of how much has been passed into the abator. Alternatively, a continuous gas monitor can be located down stream of the abator in exhaust duct 8. This gas monitor can then indicate when the ethylene oxide is starting to break through the abator. Gas monitors of this type are known in the prior art, for example a monitor of this type is available from ChemDAQ Inc, Pittsburgh, Pa. When the monitor indicates that EtO is starting to come through the absorption medium, it is time for the absorption medium to be regenerated. Some users may optionally prefer to perform the regeneration cycle on a regular cycle before the medium is completely spent.

When it is determined that the abator should be regenerated, the gas stream flow down duct 2 is turned either off or directed to a second abator depending on the requirements of the facility. Valves 3 and 7 are closed to seal off the gas ducts 2 and 8. The regeneration solution enters the absorption chamber 1 through inlet 9 and valve 10 until the liquid level in the absorption chamber 1 absorption bed exceeds the height of the absorption medium (not shown), typically between about 30% to 100% of the height of the absorption chamber 1 and preferably between 70 to 90% of the height of the absorption chamber 1. Once the regeneration solution reaches its optimum height, solution inlet valve 10 is closed. Determination of when the regeneration solution is at optimum height may be determined by any conventional means. The preferred method is a liquid height sensor (not shown) in the wall of the absorption chamber located at approximately the optimum liquid height. In addition, it is preferable to include a means for pressure relief within the absorption chamber as the regeneration solution liquid level changes. A small tube (not shown) connected from the top of the absorption chamber 1 to the exhaust duct 8 at the top of the regeneration chamber, that is closed during normal operation of the abator may be used for this purpose, but many other means will be apparent to those skilled in the art in light of this disclosure.

The regeneration liquid is left in the absorption chamber 1 for sufficient time for the regeneration process to go substantially to completion. The absorption medium may optionally be agitated or heated in the regeneration liquid to enhance the regeneration process; the agitation and/or heating means is conventional and is not shown in FIG. 1. The time and temperature required will depend on the type of the absorption medium and the properties of the regeneration liquid as well as on temperature and degree of agitation. The optimum time and temperature for any given selection of absorption medium and regeneration liquid may be determined by simple experimentation, as will be obvious to those persons skilled in the chemical arts in light of this disclosure.

At the completion of the regeneration cycle, liquid outlet valve 11 opens and the regeneration solution flows down pipe 12 to the drain (not shown). The absorption medium is prevented from flowing down the pipe 12 by means of a conventional fine screen 13. The screens 4, 6 and 13 are selected such that the particle size of the absorption medium is too large to pass through the pores/openings in the screens.

At the completion of the regeneration cycle, heat may be applied or air (heated or ambient) may be forced through the medium for sufficient time to remove the excess liquid. If there is too much water remaining in the absorption medium, then the gas contact area of the absorption medium will be reduced and the abator will be less efficient.

The absorption medium may be any material that chemically reacts with ethylene oxide to form a bound product on the surface or within the pore structure of the absorption medium. The term surface includes not only the exterior surface but also the interior surface that arises is for example the absorption medium is reticulated or porous.

The preferred absorption medium is an ion exchange resin, and the more preferred absorption medium is a polystyrene based ion exchange. The even more preferred absorption medium is a polystyrene based ion exchange resin with sulfonic acid functional groups and the most preferred absorption medium is a polystyrene based ion exchange resin with sulfonic acid functional groups in the hydrogen form. Ion exchanges are well known in the prior art and many different types of ion exchange will be apparent to those experienced in the use of ion exchange resins in light of this disclosure. Other non-ion exchange resins are also suitable materials as regeneration materials, including silicas, micas, alumina and zeolites and other solid supports that have a strong acid or strong base functionality chemically bound to the surface.

The regeneration solution is any solution that can physically or chemically react with the bound ethylene oxide products and render them soluble in the regeneration solution and leave the absorption medium in a form that on removal of substantially all of the regeneration solution, can bind ethylene oxide to form a bound product on the surface of within the pore structure of the absorption medium.

The regeneration solution is preferably primarily water and may optionally contain acid or base to make it low or high pH, depending on the selection of the absorption medium. The addition of other additives such as transition metal ions to catalyze hydrolysis reactions and surfactants to improve wetting of the absorption medium and solubilization the ethylene oxide reaction products are within the scope of this invention. In light of this disclosure the formulation of a regeneration solution will be water or preferably water containing up to 1M (more preferably 0.01 to 0.1M) sulfuric acid or other acid dissolved therein. It is necessary to ensure that all components of the abator that contact the regeneration solution are chemically compatible with the regeneration solution used.

Acid hydrolysis is a widely used means of abatement of ethylene oxide emissions. The abator contains a solution of dilute sulfuric acid and the ethylene oxide is contacted with the solution, resulting in the acid catalyzing the hydrolysis of ethylene oxide to from ethylene glycol. In the prior art, the abator is used until the ethylene glycol concentration within the abator fluid reaches such a high concentration that the abatement of ethylene glycol is no longer effective and the solution is then discarded.

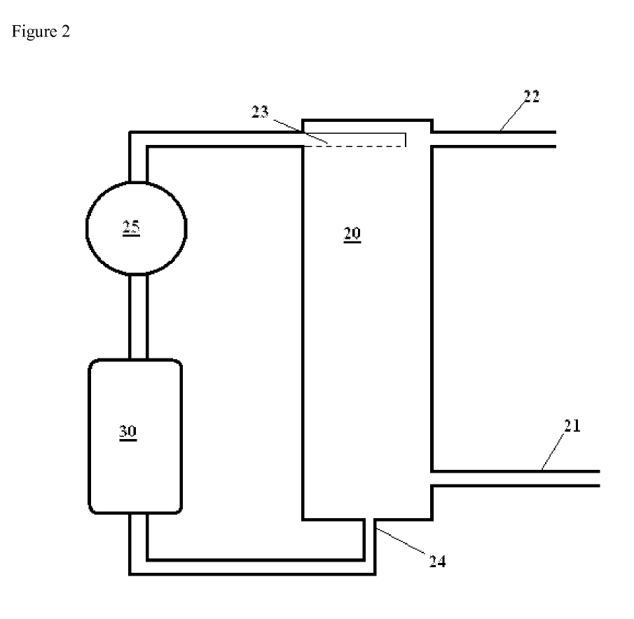

FIG. 2 shows an ethylene oxide abator according to the present invention. The abator consists of an abator vessel 20. The air stream containing the ethylene oxide is fed into the abator vessel 20 via inlet 21 and the air stream passes up through the abator vessel 20 until it leaves through outlet 22. The acid solution enters the abator vessel at the liquid inlet 23 of the abator vessel 20 and passes down to the bottom of the abator vessel and out through the liquid outlet 24. The acid solution is pumped by conventional pump 25 up through regeneration chamber 30 back to the top liquid inlet 23 of the abator vessel 20.

The abator vessel 20 contains conventional means to provide a high surface area contact between the air containing the ethylene oxide and the acid solution. A high surface area ensures the optimum reaction between the acid and the ethylene oxide and so provides for efficient abatement of the ethylene oxide concentrations. Typically the polluted gas stream is brought into contact with the scrubbing liquid, by spraying it with the liquid, by forcing it through a pool of liquid, or by some other contact method, so as to remove the pollutants; and many designs are known in the prior art (see for example, H. E. Hesketh “Air Pollution Control” Ann Arbor Science, Ann Arbor, Mich. (1979), chapter 5.

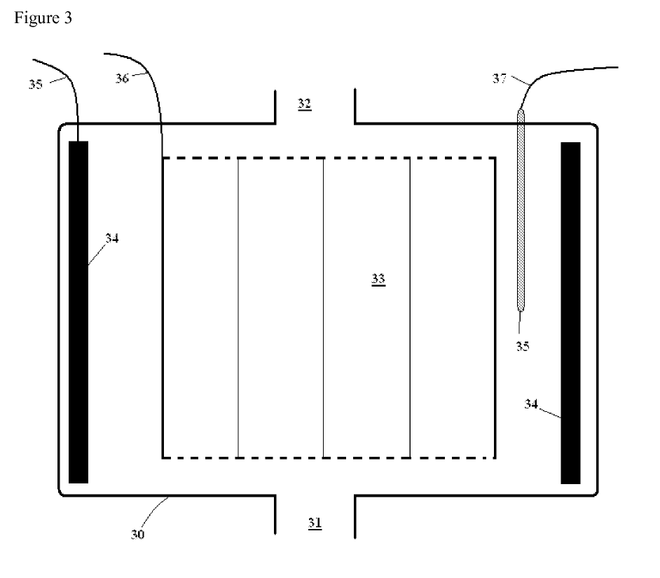

The regeneration chamber 30 is an electrochemical cell, shown in FIG. 3. The acid solution enters the regeneration chamber via port 31 and out through port 32. The regeneration chamber 30 has at least two electrodes, a working electrode 33, a counter electrode 34 and optionally a reference electrode 35. The working electrode is designed to give a high surface area contact with the acid solution and may for example be a series of plates, or more preferably a high surface area reticulated and/or porous material, such as graphite foam or graphite cloth, or glassy carbon or a wire mass etc. The counter electrode 34 should be material that is stable in the acid solution and preferably one that does not polarize excessively under current draw conditions. Suitable materials include precious metals, titanium, lead and other metals and alloys known to be stable in dilute sulfuric acid solution.

The physical shape of counter electrode 34 ideally will provide uniform current density across the working electrode 33, and an annular form is preferred. The reference electrode 35, if used, should be suitable for use in dilute sulfuric acid. Many reference electrodes are available, but the preferred reference electrode 35 is a metal/metal oxide, where the metal is a platinum group metal. However, the selection of electrode materials, their physical form and their shape are well known to those experienced in the art of electrochemistry and many variations are known that will work within the scope of this invention.

The potential of the working electrode 33 will be held at a fixed value relative to the counter electrode 34 if only two electrodes are used in the electrochemical cell. If three electrodes are used, the potential of the working electrode 33 will normally be held at a fixed value relative to the reference electrode 35.

If the potential is held at a constant voltage, then the current flowing through the cell (working 33 to counter electrodes 34) can be used as a measure of the regeneration process and the status of the cell. Alternatively, the regeneration cell may operate at constant current, in which case the potential across the cell (or internal resistance) can be used to as a measure of the regeneration process. Constant potential operation is the preferred mode of operation of the regeneration cell. Other electrochemical techniques such as impedance measurement can be used to assess the status of the regeneration cell and regeneration process and additionally, electrochemical techniques such as voltage pulsing the electrodes may be used to maintain the electrodes in optimum condition, are within the scope of this invention.

The drive circuitry for two and three electrode electrochemical cells is well known in the prior art. The optimum potential of the working electrode 33 will depend on the composition of the working electrode 33 and homogeneous and heterogeneous catalysts employed in the electrochemical cell as is discussed below. The methods for determining the optimum potential are well known to those experienced in the art of electrochemistry. Optionally, higher positive or negative voltages can be applied intermittently to the working electrode 33 for the purposes of cleaning the electrodes.

The oxidation of ethylene glycol is a multi-step reaction and various intermediary products are formed before the final formation of carbon dioxide. The oxidation of ethylene glycol and its oxidation products is greatly facilitated by use of one or more catalysts. In one embodiment of this invention, the surface of the working electrode 31 includes an electrocatalyst suitable for the oxidation of ethylene glycol to carbon dioxide and water. A suitable material for such a catalyst is high surface area platinum black or palladium black or rhodium black, other precious metals, combinations thereof as mixtures or alloys, and/or transition metal complexes

In another embodiment of this invention, the acid solution, which also serves as electrolyte for the electrochemical cell contains a homogenous redox catalyst. The reduced form of the catalyst is oxidized at the working electrode 33 to form the oxidized form of the catalyst and the oxidized form of the catalyst then oxidizes the ethylene glycol and its oxidation products, reforming the reduced form of the catalyst. Many potential redox catalysts are known including platinum and palladium compounds are suitable, as well as manganese, cobalt, other transition metal complexes and cerium salts. These homogenous catalysts may be used with catalytically unreactive electrodes or in combination with a catalytically active working electrode. The prior art contains many references to the electrochemical oxidation of ethylene glycol and the selection of the alternate heterogeneous and/or homogeneous catalyst systems is within the skill of those experienced in the art of electrochemistry.

While the various embodiments of the present invention have been written describing the abatement of ethylene oxide, the invention may also be used for the regeneration of absorption media for other gases where the reaction products of the abated gas can be washed off the absorption medium or where the reaction products of the abated gas can be removed by electrochemical oxidation from the abator solution.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1) A method for the regeneration of an abator for ethylene oxide in a gas stream wherein the ethylene oxide reacts with a solid absorbent material to form a reaction product that is bound to the surface of the said absorbent material, so as to substantially remove all of the ethylene oxide from the said gas stream; the said reaction product being substantially removed from the said absorbent material by first washing the absorbent material with an aqueous solution, such that the ethylene oxide absorbing ability of the said absorbent material is restored.

2) The method of claim 1 wherein the aqueous solution is purified water

3) The method of claim 1 wherein the aqueous solution is acidified purified water.

4) The method of claim 1 wherein the solid absorbent material is an ion exchange resin

5) The method of claim 4 wherein the ion exchange resin is a polystyrene resin with surface sulfonic acid groups

6) The method of claim 4 wherein the ion exchange resin is in the acid form

7) The method of claim 4 wherein the ion exchange resin is in the basic form.

8) The method of claim 1 wherein the regeneration cycle is triggered based on an indication of ethylene oxide break through, as determined by a continuous gas monitor for ethylene oxide down stream of the absorption material.

9) The method of claim 1 wherein the gas stream is the exhaust gas from a sterilizer.

10) The method of claim 1 wherein the absorption medium is at least partially dried by heat, by blowing air through the medium of by combination of both heat and forced air upon completion of the absorption material regeneration process.

11) A method for the abatement of ethylene oxide in a gas stream wherein the ethylene oxide reacts with an aqueous acidic solution to form a reaction product, so as to substantially remove all of the ethylene oxide from the said gas stream; the said reaction product being substantially removed from the said aqueous solution by electrochemical oxidation of the reaction product, thus extending the service life of the acid solution.

12) The method of claim 11 wherein the aqueous solution is a mineral acid, including sulfuric acid.

13) The method of claim 11 wherein the electrochemical cell contains a high surface area catalytically active working electrode

14) The method of claim 13 wherein the working electrode includes a heterogeneous redox catalyst.

15) The method of claim 13 wherein the working electrode includes a platinum group metal

16) The method of claim 11 wherein the aqueous solution includes a homogenous redox catalyst capable of catalyzing the electrochemical oxidation of ethylene glycol.

17) The method of claim 11 wherein the electrochemical cell is in operation continuously.

18) The method of claim 11 wherein the gas stream is the exhaust gas from a sterilizer.

19) The method of claim 11 wherein the electrochemical cell is operated in constant potential mode or constant current mode.
